(19) United States
(12) Patent Application Publication
(10) Pub. No.: US 2014/0021794 A1
(43) Pub. Date: Jan. 23, 2014

(54) WIRELESS POWER TRANSFER DEVICES

(71) Applicant: Electronics and Telecommunications Research Institute, (US)

(72) Inventors: Yong Hae KIM, Daejeon (KR); Sang Hoon CHEON, Daejeon (KR); Seung Youl KANG, Daejeon (KR); Myung Lae LEE, Daejeon (KR); Taehyoung ZYUNG, Daejeon (KR)

(73) Assignee: Electronics and Telecommunications Research Institute, Daejeon (KR)

(21) Appl. No.: 13/717,798

(22) Filed: Dec. 18, 2012

(30) Foreign Application Priority Data
Jul. 17, 2012 (KR) 10-2012-0077649

(51) Int. Cl. H01F 38/14

(52) U.S. Cl. CPC H01F 38/14
USPC 307/104

(57) ABSTRACT

Wireless power transfer devices are provided. The wireless power transfer device may include a plurality of stacked resonance structures, and adhesive layers between the resonance structures. Each of the resonance structures includes a base board including a base coil, interposer boards including interposer coils and stacked on the base board, and conductive pillars penetrating the base board and the interposer board. The conductive pillars connect the interposer boards to each other.

### CROSS-REFERENCE TO RELATED APPLICATIONS

This U.S. non-provisional patent application claims priority under 35 U.S.C. §119 to Korean Patent Application No. 10-2012-0077649, filed on Jul. 17, 2012, the entirety of which is incorporated by reference herein.

### BACKGROUND

The inventive concept relates to wireless power transfer devices and, more particularly, to wireless power transfer devices with low resonance frequencies.

Recently, performances of electronic products have increasingly developed. Particularly, portable electronic devices have been miniaturized by developments of a semiconductor technique and a display technique. However, power may be applied to the electronic devices through cables. Some of the electronic devices may use a charger. However, the electronic devices may be used for only a predetermined time by limitation of charging capacity thereof. The electronic devices should be reapplied with the power through the cables after the predetermined time. Wireless charging techniques have been developed for overcoming the problems. The wireless charging techniques may use a radio frequency or magnetic induction.

If the power is wirelessly applied, it is possible to prevent a short of the electronic devices caused by water and the electronic devices may be safely used. Additionally, lines for charging may be eliminated to be helpful to a beautiful view. However, a distance for generating the magnetic induction may be very short to cause various problems. A resonance wireless power transfer technique has been suggested.

### SUMMARY

Embodiments of the inventive concept may provide wireless power transfer devices with high reliability.

In an aspect, a wireless power transfer device may include: a plurality of stacked resonance structures; and adhesive layers between the resonance structures. Each of the resonance structures may include a base board including a base coil, interposer boards including interposer coils and stacked on the base board, and conductive pillars penetrating the base board and the interposer board; and the conductive pillars may connect the interposer boards to each other.

In an embodiment, a length of one side of each of the resonance structures may be about 5 cm.

In an embodiment, a total stack number of the base board and the interposer boards may be eight in each of the resonance structures.

In an embodiment, each of the resonance structures may have a thickness of about 0.73 mm.

In an embodiment, each of the adhesive layers may have a thickness of about 0.05 mm.

In an embodiment, the base coil may include a base induction coil and a base resonance coil; each of the base induction coil and the base resonance coil may extend in a first rotation direction; and a turn number of the base resonance coil may be greater than a turn number of the base induction coil.

In an embodiment, the interposer boards may include first interposer boards and second interposer boards which are alternately stacked; each of the first interposer boards may include a first interposer induction coil and a first interposer resonance coil; and each of the second interposer boards may include a second interposer induction coil and a second interposer resonance coil.

In an embodiment, a turn number of the first interposer induction coil may be equal to a turn number of the second interposer induction coil.

In an embodiment, a turn number of the first interposer resonance coil may be greater than a turn number of the first interposer induction coil; and a turn number of the second interposer resonance coil may be greater than a turn number of the second interposer induction coil.

In an embodiment, the first interposer resonance coil may extend in a first rotation direction; and the second interposer resonance coil may extend in a second rotation direction opposite to the first rotation direction.

In an embodiment, the conductive pillars may include a first conductive pillar, a second conductive pillar, a third conductive pillar, and a fourth conductive pillar. The first conductive pillar may connect first ends of the base induction coil, the first interposer induction coils, and the second interposer induction coils to each other; the second conductive pillar may connect second ends of the base induction coil, the first interposer induction coils, and the second interposer induction coils to each other; the third conductive pillar may connect one-end of the base resonance coil and one-ends of the second interposer resonance coils to each other; and the fourth conductive pillar may connect one-ends of the first interposer resonance coils to each other.

In an embodiment, each of the base board and the interposer boards may be formed of a printed circuit board.

In an embodiment, the wireless power transfer device may further include: an inductance structure bonded to an uppermost layer or a lowermost layer of the resonance structures.

In an embodiment, the inductance structure may include inductance boards and conduction board which are stacked; and the inductance boards may include inductance coils and the conduction board may include conduction coil, respectively.

In an embodiment, the inductance structure may further include a first inductance conductive pillar connecting first ends of the inductance coils to each other, and a second inductance conductive pillar connecting second ends of the inductance coils to each other.

In an embodiment, a length of one side of the inductance structure may be about 5 cm.

### BRIEF DESCRIPTION OF THE DRAWINGS

The inventive concept will become more apparent in view of the attached drawings and accompanying detailed description.

FIG. 1 is a cross-sectional view illustrating a wireless power transfer device according to some embodiments of the inventive concept;

FIG. 2 is a cross-sectional view illustrating a resonance structure included in the wireless power transfer device of FIG. 1;

FIGS. 3A, 3B, and 3C are plan views illustrating a base board, a first interposer board, a second interposer board included in a resonance structure according to some embodiments of the inventive concept, respectively;

FIG. 4 is a perspective view illustrating base coils, first interposer coils, second interposer coils and conductive pillars in a resonance structure according to some embodiments of the inventive concept;

FIGS. 5 to 8 are graphs illustrating characteristics of a wireless power transfer device according to some embodiments of the inventive concept;

FIG. 9 is a cross-sectional view illustrating a wireless power transfer device including an inductance structure according to other embodiments of the inventive concept; and

FIGS. 10A, 10B, 10C, and 10D are plan views illustrating boards of an inductance structure of a wireless power transfer device according to other embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or board is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

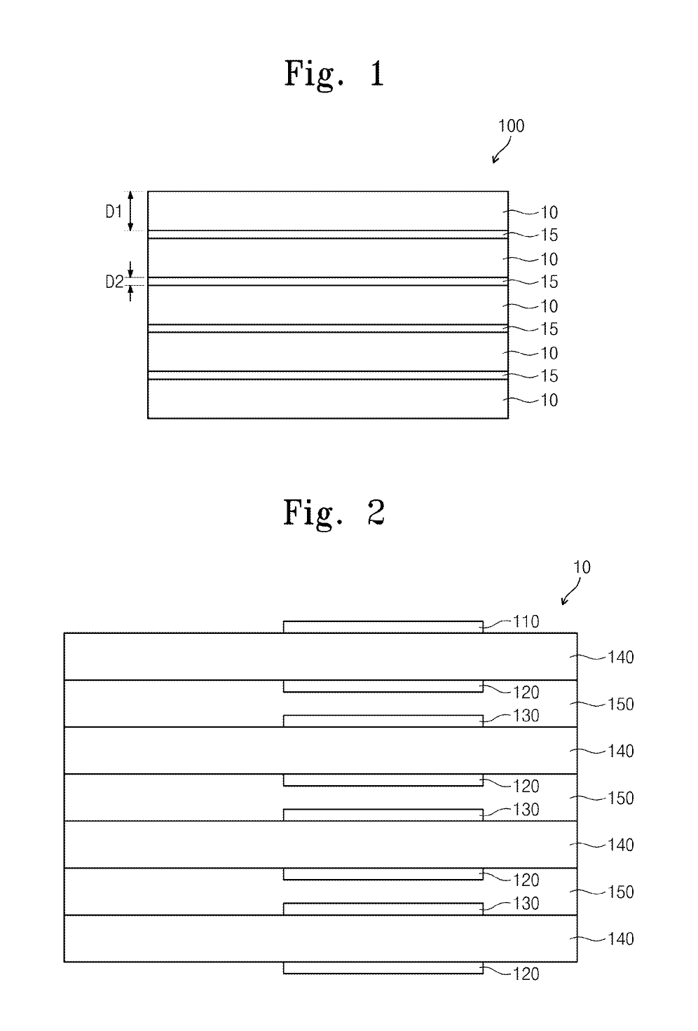

FIG. 1 is a cross-sectional view illustrating a wireless power transfer device according to some embodiments of the inventive concept.

Referring to FIG. 1, a wireless power transfer device 100 according to some embodiments may include a plurality of resonance structures 10 which are sequentially stacked. Adhesive layers 15 may be disposed between the resonance structures 10. The resonance structures 10 may be bonded to each other the by adhesive layers 15. Each of the resonance structures 10 may have a thickness D1 of about 0.73 mm, and each of the adhesive layers 15 may have a thickness D2 of about 0.05 mm. Each of the resonance structures 10 may include eight printed circuit boards which are sequentially stacked. Coils may be disposed on each of the eight printed circuit boards. The coils of the eight printed circuit boards may be electrically connected to each other by conductive pillars, such that the eight printed circuit boards may be electrically connected to each other.

The wireless power transfer device 100 may be a transmitting part applying power or a receiving part. The transmitting part may include a transmitting induction coil (power coil) and the transmitting resonance coil. The receiving part may include a receiving induction coil (load coil) and the receiving resonance coil. The power applied to the power coil may be transmitted through magnetic resonance due to the transmitting resonance coil. In more detail, if a resonance frequency of the transmitting resonance coil is equal to a resonance frequency of the transmitting resonance coil, the power may be transmitted from the power coil to the load coil. Thus, a power transfer distance between the transmitting part and the receiving part may increase.

The number of the coils included in the resonance structures 10 should increase for the lowering resonance frequency of the wireless power transfer device 100. To achieve this, the resonance structures 10 may be stacked using the adhesive layers 15. On the other hand, a size of the wireless power transfer device 100 may be reduced, such that sizes of the coils may be reduced to increase the resonance frequency. However, according to embodiments of the inventive concept, the resonance structures 10 having small sizes may be stacked to increase the number of the coils, so that the resonance frequency may be reduced and the wireless power transfer device 100 having a small size may be realized. Additionally, the wireless power transfer device 100 may have the resonance frequency of about 100 kHz or less and improved power transfer efficiency.

FIG. 2 is a cross-sectional view illustrating a resonance structure included in the wireless power transfer device of FIG. 1.

Referring to FIG. 2, the resonance structure 10 may include a base board 110, first interposer boards 120, and second interposer boards 130. The first interposer boards 120 and the second interposer boards 130 may be alternately stacked on the base board 110. The base board 110 may be a printed circuit board. The first interposer boards 120 may be four printed circuit boards, and the second interposer boards 130 may be three printed circuit boards. In other words, the resonance structure 10 may include eight printed circuit boards.

A first material layer 140 may be disposed on one surface of each of the first interposer boards 120. One of the first material layers 140 may be disposed between the base board 110 and the first interposer board 120 adjacent to the base board 110. Each of the others of the first material layers 140 may be disposed between the first interposer board 120 and the second interposer board 130 adjacent to each other. The first material layers 140 may be copper clad laminated (CCL) layers. The first material layers 140 may insulate the base board 110, the first interposer boards 120, and the second interposer boards 130 from each other. Each of the first material layers 140 may have a thickness of about 0.1 mm.

Second material layers 150 may be disposed between the first material layers 140. Each of the second material layers 150 may be disposed between the first material layers 140 adjacent to each other. The first material layers 140 and the second material layers 150 may be alternately stacked. Each of the second material layers 150 may completely cover the first and second interposer boards 120 and 130 disposed between the first material layers 140 adjacent to each other. The second material layers 150 may be prepreg layers. The second material layers 150 may insulate the first interposer boards 120 and the second interposer boards 130 from each other. Each of the second material layers 150 may have a thickness of about 0.11 mm.

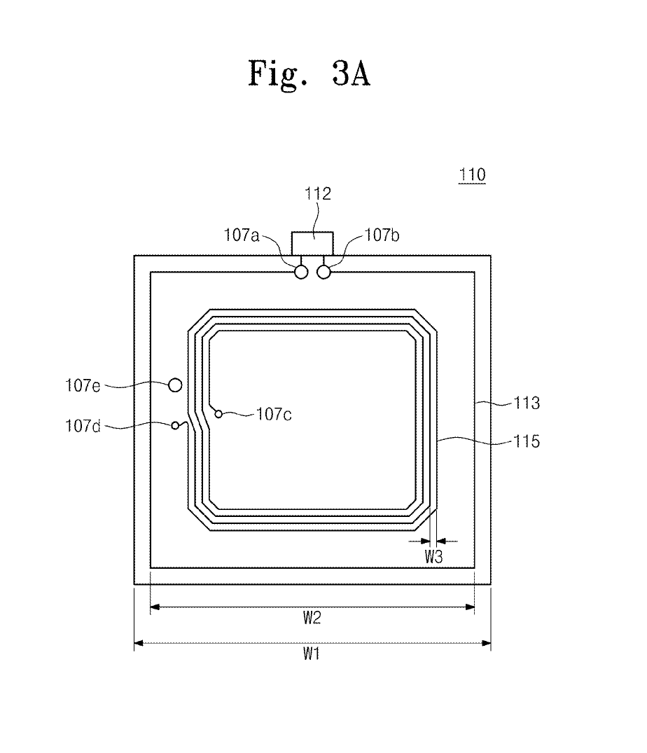

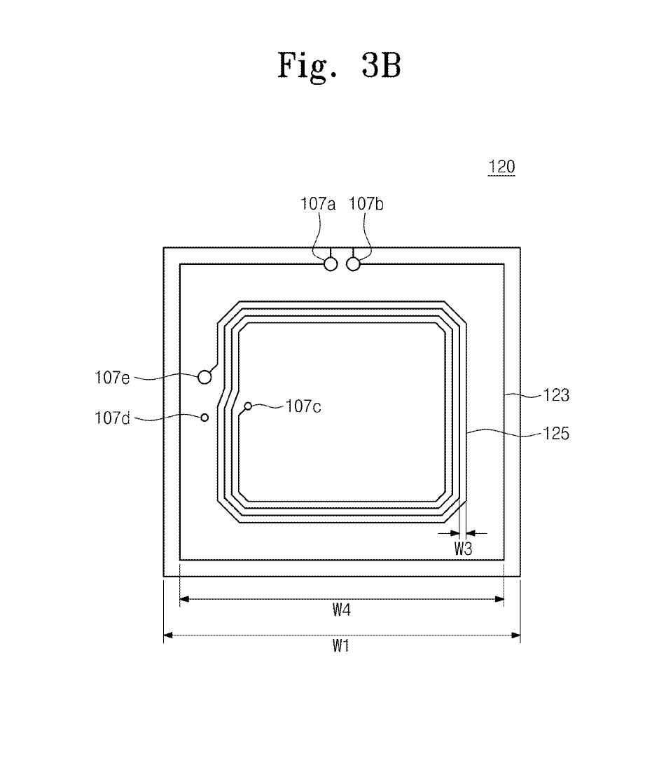

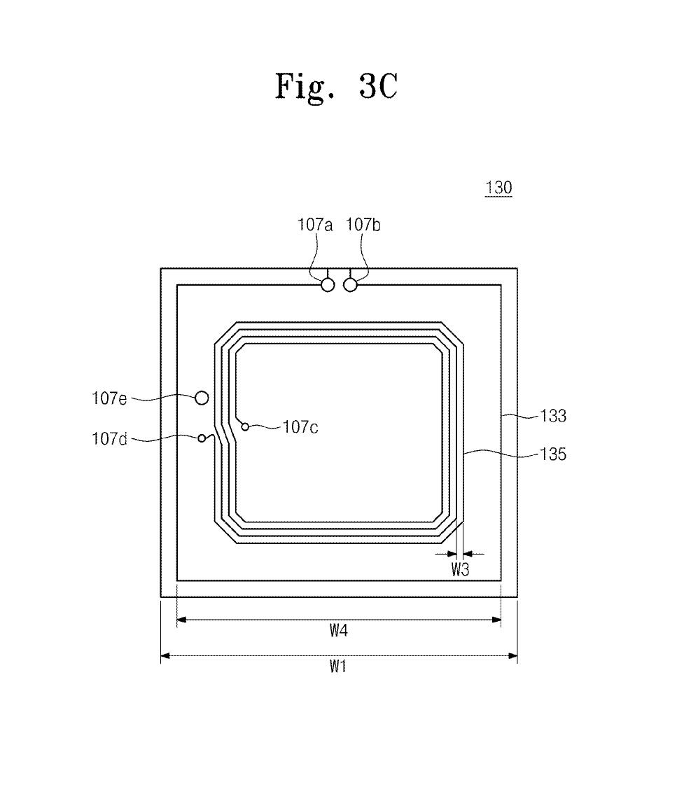

FIG. 3A is a plan view illustrating a base board included in the resonance structure of FIG. 2.

FIG. 3B is a plan view illustrating a first interposer board included in the resonance structure of FIG. 2.

FIG. 3C is a plan view illustrating a second interposer board included in the resonance structure of FIG. 2.

Referring to FIG. 3A, the base board 110 may include a connector 112, a base induction coil 113, a base resonance coil 115, and through-holes 107a, 107b, 107c, 107d, and 107e. For example, the base board 110 may include first, second, third, fourth, and fifth through-holes 107a, 107b, 107c, 107d, and 107e. The base board 110 may be electrically connected to the first interposer boards 120 and the second interposer boards 130 of FIG. 2 by conductive pillars passing through the through-holes 107a, 107b, 107c, 107d, and 107e. A width W1 of the base board 110 may be about 5 cm, and the base board 110 may have a square-shape in a plan view.

The connector 112 may be disposed on one end of the base board 110.

The connector 112 may be provided for connection of an electronic device. The connector 112 may be a sub-miniature type A (SMA) connector.

The first and second through-holes 107a and 107b may be disposed to be spaced apart from each other. The first and second through-holes 107a and 107b may be disposed to face the connector 112.

The base induction coil 113 may be disposed on an edge of the base board 110. A copper layer may be disposed on the base board 100 and then the copper layer may be patterned to form the base induction coil 113. The base induction coil 113 may extend along the edge of the base board 110 from the second through-hole 107b to the first through-hole 107a. The base induction coil 113 may connect the second through-hole 107b to the first through-hole 107a. A rotation direction from the second through-hole 107b to the first through-hole 107a may be defined as a first rotation direction. The first rotation direction may be a clockwise direction. A turn number of the base induction coil 113 may be 1. The base induction coil 113 may be connected to the connector 112 at the first and second through holes 107a and 107b. The base induction coil 113 may have a diameter of about 1 mm. A spacing distance W2 between portions of the base induction coil 113 facing each other may be about 4.8 cm.

The base resonance coil 115 may be surrounded by the base induction coil 113. A maximum spacing distance between portions of the base resonance coil 115 may be smaller than a maximum spacing distance between portions of the base induction coil 113. A copper layer may be formed on the base board 110 and then the copper layer may be patterned to form the base resonance coil 115. The base resonance coil 115 may extend in the first rotation direction. The base resonance coil 115 may extend from the fourth through-hole 107d to the third through-hole 107c. The base resonance coil 115 may connect the fourth through-hole 107d to the third through-hole 107c. The third through-hole 107c may be disposed inside the base resonance coil 115 in a plan view, and the fourth through-hole 107d may be disposed outside of the base resonance coil 115 in a plan view. A turn number of the base resonance coil 115 may be greater than the turn number of the base induction coil 113. The base induction and resonance coils 113 and 115 may be a power coil or a load coil. The base resonance coil 115 may have a diameter of about 1 mm. A minimum spacing distance W3 between portions of the base resonance coil 115 facing each other may be about 0.1 mm. A length of the base resonance coil 115 may be about 880 cm.

The fifth through-hole 107e may be spaced apart from the base resonance coil 115 and be disposed outside the base resonance coil 115 in a plan view. The fifth through-hole 107e may be spaced apart from the fourth through-hole 107d.

FIG. 3B is a plan view illustrating a first interposer board included in the resonance structure of FIG. 2.

Referring to FIG. 3B, the first interposer board 120 may include a first interposer induction coil 123, a first interposer resonance coil 125, and through-holes 107a, 107b, 107c, 107d, and 107e. For example, the through-holes 107a to 107e of the first interposer board 120 may include first, second, third, fourth, and fifth through-holes 107a to 107e. The through-holes 107a to 107e penetrating the first interposer board 120 may be overlapped with the through-holes 107a to 107e penetrating the base board 110 of FIG. 3A, respectively. A width W1 of the first interposer board 120 may be about 5 cm, and the first interposer board 120 may have a square-shape in a plan view.

The first and second through-holes 107a and 107b of the first interposer board 120 may be spaced apart from each other and be disposed at a portion of an edge of the first interposer board 120.

The first interposer induction coil 123 may be disposed on the edge of the first interposer board 120. The first interposer induction coil 123 may be formed by the same method as the base induction coil 113. The first interposer induction coil 123 may have the same turn number as the base induction coil 113 and extend in the same rotation direction as the base induction coil 113. The first interposer induction coil 123 may extend along the edge of the first interposer board 120 from the second through-hole 107b to the first through-hole 107a on the first interposer board 120. The first interposer induction coil 123 may connect the second through-hole 107b to the first through-hole 107a of the first interposer board 120. The first interposer induction coil 123 may extend in the first rotation direction (e.g., the clockwise direction). The turn number of the first interposer induction coil 123 may be 1. The first interposer induction coil 123 may have a diameter of about 1 mm. A spacing distance W4 between portions of the first interposer induction coil 123 facing each other may be about 4.5 cm.

The first interposer resonance coil 125 may be disposed on the first interposer board 120. The first interposer resonance coil 125 may be surrounded by the first interposer induction coil 123. A maximum spacing distance between portions of the first interposer resonance coil 125 may be smaller than a maximum spacing distance between portions of the first interposer induction coil 123. The first interposer resonance coil 125 may extend in a second rotation direction opposite to the first rotation direction. In other words, the first interposer resonance coil 125 may extend in a rotation direction opposite to the rotation direction of the base resonance coil 115. The second rotation direction may be a counterclockwise direction. The first interposer resonance coil 125 may connect the third through-hole 107c to the fifth through-hole 107e of the first interposer board 120. The third through-hole 107c of the first interposer board 120 may be disposed inside the first interposer resonance coil 125 in a plan view, and the fifth through-hole 107e may be disposed outside of the first interposer resonance coil 125 in a plan view. A turn number of the first interposer resonance coil 125 may be greater than the turn number of the first interposer induction coil 123. The first interposer resonance coil 125 may have a diameter of about 0.1 mm. A minimum spacing distance W3 between portions of the first interposer resonance coil 125 facing each other may be about 0.1 mm. A length of the first interposer resonance coil 125 may be about 800 cm.

The fourth through-hole 107d of the first interposer board 120 may be spaced apart from the first interposer resonance coil 125 and be disposed outside the first interposer resonance coil 125 in a plan view. The fourth through-hole 107d of the first interposer board 120 may be spaced apart from the fifth through-hole 107e.

Referring to FIG. 3C, the second interposer board 130 may include a second interposer induction coil 133, a second interposer resonance coil 135, and through-holes 107a, 107b, 107c, 107d, and 107e. For example, the through-holes 107a to 107e of the first interposer board 130 may include first, second, third, fourth, and fifth through-holes 107a to 107e. The through-holes 107a to 107e penetrating the second interposer board 130 may be overlapped with the through-holes 107a to 107e penetrating the base board 110 of FIG. 3A, respectively. A width W1 of the second interposer board 130 may be about 5 cm, and the second interposer board 130 may have a square-shape in a plan view.

The second interposer induction coil 133 may be disposed on an edge of the second interposer board 130. The second interposer induction coil 133 may be formed by the same method as the base induction coil 113. The second interposer induction coil 133 may have the same turn number as the base induction coil 113 and extend in the same rotation direction as the base induction coil 113. The second interposer induction coil 133 may have a diameter of about 1 mm. A spacing distance W4 between portions of the second interposer induction coil 133 facing each other may be about 4.5 cm.

The second interposer resonance coil 135 may be disposed at a position overlapped with the base resonance coil 115 and extend in the same rotation direction as the base resonance coil 115. Thus, the third through-hole 107c of the second interposer board 130 may be disposed inside the second interposer resonance coil 135 and the fourth through-hole 107d of the second interposer board 130 may be disposed outside the second interposer resonance coil 135 in a plan view. A turn number of the second interposer resonance coil 135 may be greater than the turn number of the second interposer induction coil 133. The second interposer resonance coil 135 may have a diameter of about 0.1 mm. A minimum spacing distance W3 between portions of the second interposer resonance coil 135 facing each other may be about 0.1 mm. A length of the second interposer resonance coil 135 may be about 800 cm.

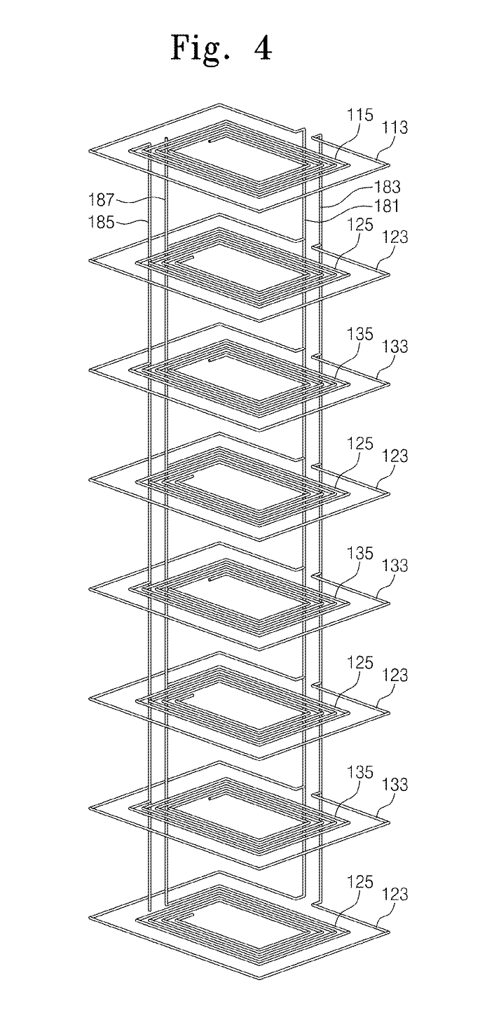

FIG. 4 is a perspective view illustrating base coils, first interposer coils, interposer coils and conductive pillars included in a resonance structure of FIG. 2.

Referring to FIG. 4, the base induction coil 113, the first interposer induction coils 123, and the second interposer induction coils 133 may be spaced apart from each other and be vertically stacked to form a coil-stack structure. The baser induction coil 113 and the base resonance coil 115 may be disposed on the same plane. The first interposer resonance coils 125 may be disposed at the same levels as the first interposer induction coils 123, respectively. The second interposer resonance coils 135 may be disposed at the same levels as the second interposer induction coils 133, respectively. The base induction and resonance coils 113 and 115 may be disposed at the uppermost plane of the coil-stack structure. The first interposer induction coils 123 and the second interposer induction coils 133 may be alternately stacked. Likewise, the first interposer resonance coils 125 and the second interposer induction coils 135 may be alternately stacked. In more detail, the first interposer induction coils 123 may be disposed at a second plane, a fourth plane, a sixth plane, and an eighth plane of the coil-stack structure, respectively. The second interposer induction coils 133 may be disposed at a third plane, a fifth plane, and a seventh plane of the coil-stack structure, respectively. The second interposer resonance coils 135 may be also disposed at the third plane, the fifth plane, and the seventh plane of the coil-stack structure, respectively. Thus, the resonance structure 10 may include the coil-stack structure having eight planes.

The resonance structure 10 may include a first conductive pillar 181, a second conductive pillar 183, a third conductive pillar 185, and a fourth conductive pillar 187 connecting the base induction and resonance coils 113 and 115, the first interposer induction and resonance coils 123 and 125, and the second interposer induction and resonance coils 133 and 135. The first, second, third, and fourth conductive pillars 181, 183, 185, and 187 may be vertical to the coils and be spaced apart from each other.

A first end of the base induction coil 113 may be connected to first ends of the first interposer induction coils 123 and first ends of the second interposer induction coils 133 through the first conductive pillar 181. A second end of the base induction coil 113 may be connected to second ends of the first interposer induction coils 123 and second ends of the second interposer induction coils 133 through the second conductive pillar 183. Since a sum of the base induction coil 113 and the first and second interposer induction coils 123 and 133 is 8, a resistance of the resonance structure 10 may be reduced to one-eighth (⅛).

One-end of the base resonance coil 115 may be connected to one-ends of the second interposer resonance coils 135 through the third conductive pillar 185. The first end of the base resonance coil 115 may be disposed outside the base resonance coil 115 in a plan view. The first ends of the second interposer resonance coils 135 may be disposed outside the second interposer resonance coils 135, respectively, in a plan view. Thus, a resistance of the base resonance coil 115 and the second interposer resonance coils 135 may be reduced to one-four (¼), and an inductance of the base resonance coil 115 and the second interposer resonance coils 135 may not be varied. Additionally, a capacitance of the base resonance coil 115 and the second interposer resonance coils 135 may increase seven times. The third conductive pillar 185 may extend to the eighth plane including the first interposer resonance coil 125 of the coil-stack structure.

One-ends of the first interposer resonance coils 125 may be connected to each other through the fourth conductive pillar 187. The one-ends of the first interposer resonance coils 125 may be respectively disposed outside the first interposer coils 125 in a plan view. Thus, a resistance of the first interposer resonance coils 125 may be reduced to one-four (¼), and an inductance of the first interposer resonance coils 125 may not be varied. Additionally, a capacitance of the first interposer resonance coils 125 may increase seven times. The fourth conductive pillar 187 may extend to the uppermost plane at which the base resonance coil 115 is disposed.

The resonance coils 115, 125, and 135 may transmit or receive a signal of an electromagnetic wave-shape by a magnetic resonance method, so as to transmit or receive power. For example, if the base coils 113, 123 and 133 are power coils, the resonance coils 115, 125, and 135 may transmit the power. Alternatively, if the base coils 113, 123, and 133 are load coils, the resonance coils 115, 125, and 135 may receive the power.

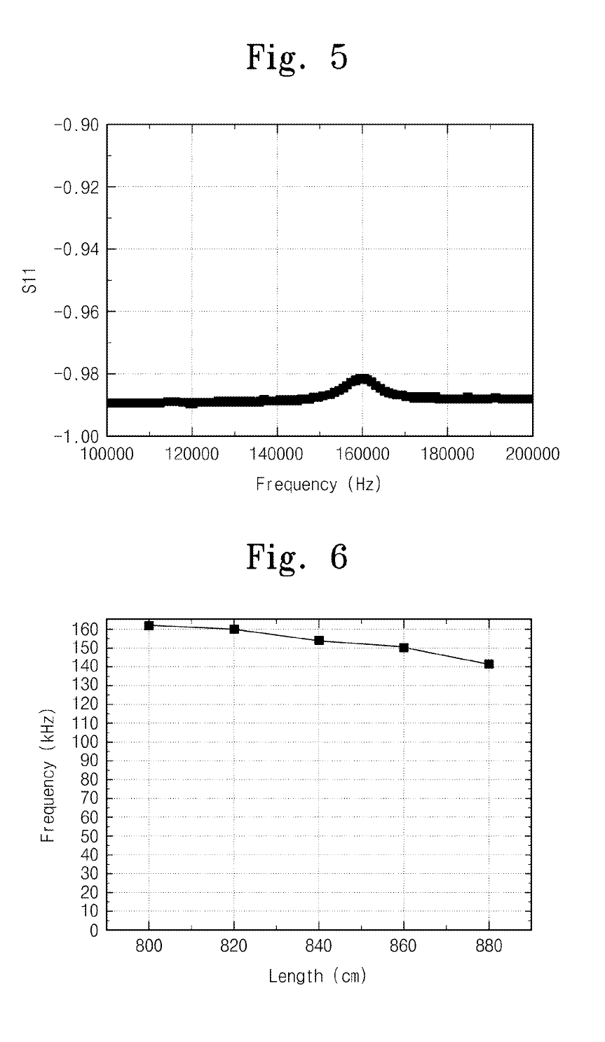

FIGS. 5 to 8 are graphs illustrating characteristics of a wireless power transfer device according to some embodiments of the inventive concept.

FIG. 5 is a graph illustrating a characteristic of a S11 parameter of a resonance structure which includes stacked eight printed circuit boards (e.g., the base board, the first interposer boards and the second interposer boards) including coils. In FIG. 5, an x-axis represents a frequency (Hz), and a y-axis represents a S11 parameter value. A resonance frequency exists at about 160 kHz in FIG. 5.

FIG. 6 is a graph illustrating a variation of the resonance frequency with respect to a length of each of the coils (the resonance coils of FIGS. 3A, 3B and 3C) included in the printed circuit boards in the resonance structure. In FIG. 6, an x-axis represents the length of the resonance coil, and a y-axis represents a frequency (kHz). As the length of each of the resonance coils increases, the resonance frequency is reduced.

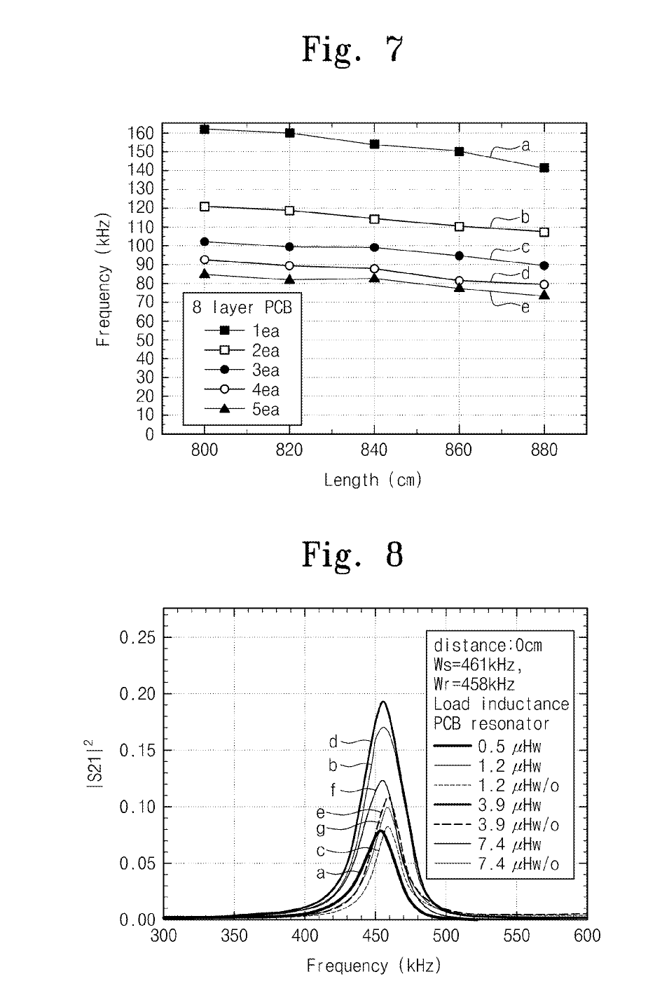

FIG. 7 is a graph illustrating the resonance frequency with respect to the stack number of the stacked resonance structures included in the wireless power transfer device. In FIG. 7, an x-axis represents lengths of the resonance coils, and a y-axis represents a frequency (kHz). In FIG. 7, reference designators “a”, “b”, “c”, “d”, and “e” represent one, two, three, four, and five stacked resonance structures, respectively. As the stack number of the stacked resonance structures increases, the resonance frequency is reduced. The resonance frequencies of the wireless power transfer devices including three or more stacked resonance structures are reduced under 100 kHz. Additionally, the wireless power transfer device including five stacked resonance structures is reduced to 73 kHz.

FIG. 8 is a graph illustrating power transfer characteristic the wireless power transfer device including two resonance structures stacked using the adhesive layer. In FIG. 8, an x-axis represents a frequency (kHz), and a y-axis represents a 1521¹² parameter value.

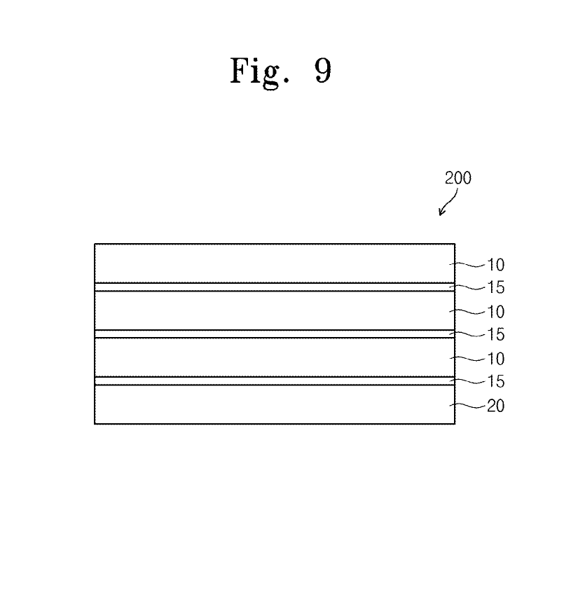

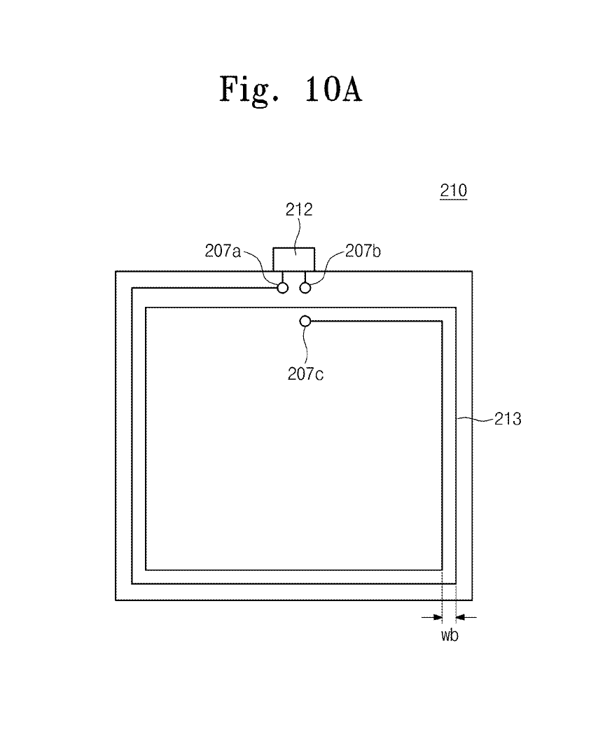

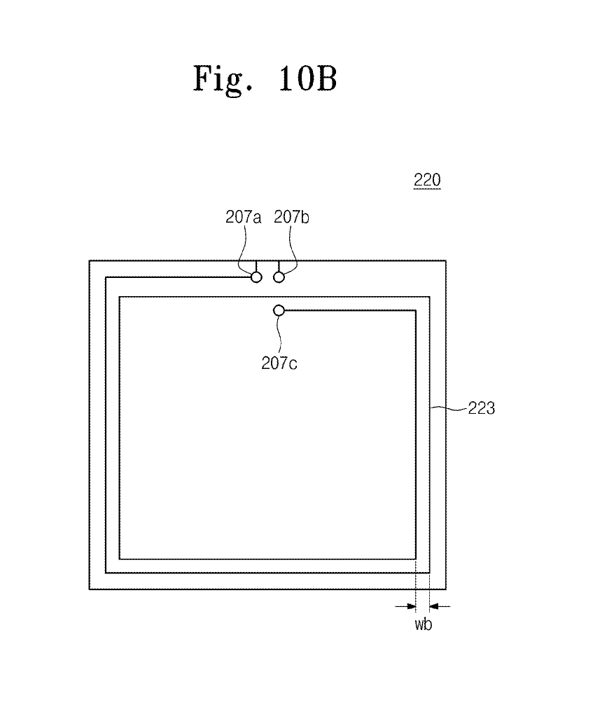

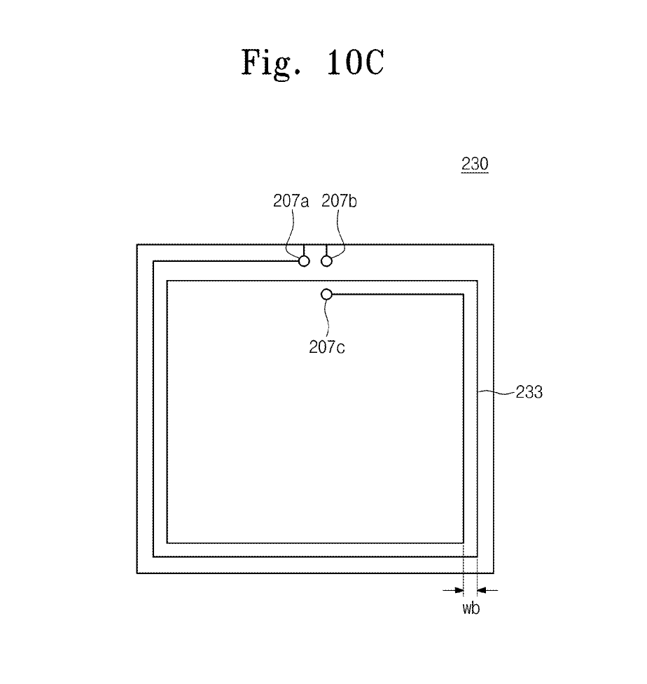

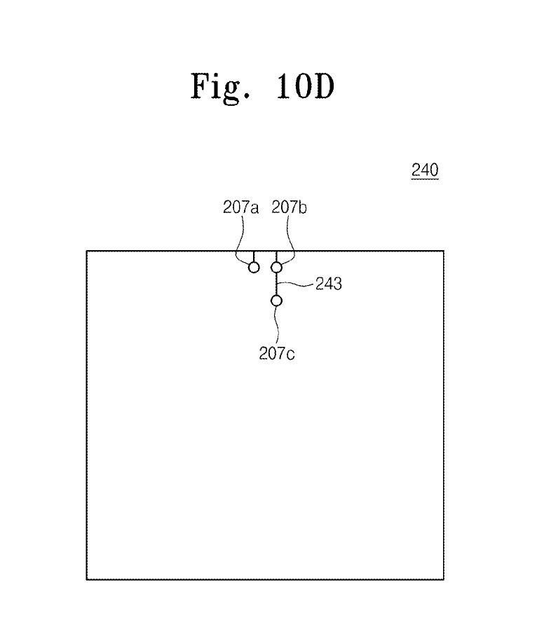

In FIG. 8, reference designators “a”, “b”, “c”, “d”, “e”, “f”, and “g” represent load inductance values of 0.5 μH, 1.2 μH, 3.9 μH and 7.4 μH, respectively. The power transfer characteristic of the wireless power transfer device is varied depending on the load inductance value. However, as described with reference to FIGS. 3A, 3B, and 3C, since the width of each of the base, first interposer, and second interposer boards is about 5 cm, the load inductance value may be fixed to 0.5 μH. Thus, a printed circuit board for the load or power inductance may be installed in the wireless power transfer device. The wireless power transfer device including the printed circuit board for the load inductance will be described with reference to FIGS. 9 and 10A to 10D.

FIG. 9 is a cross-sectional view illustrating a wireless power transfer device including an inductance structure according to other embodiments of the inventive concept.

Referring to FIG. 9, a wireless power transfer device 200 may include three resonance structures 10 and an inductance structure 20 which are stacked to constitute a stack structure. The three resonance structures 10 and the inductance structure 20 may be bonded to each other by adhesive layers 15. The inductance structure 20 may be disposed at the uppermost layer or the lowermost layer of the stack structure. Due to the inductance structure 20, the wireless power transfer device 200 may have a square-shape of about 5 cm and improved power transfer efficiency under 100 kHz.

FIGS. 10A, 10B, 10C, and 10D are plan views illustrating boards of the inductance structure of the wireless power transfer device of FIG. 9.

Referring to FIGS. 9 and 10A to 10D, the inductance structure 20 may include a first inductance board 210, a second inductance board 220, a third inductance board 230, and a fourth conduction board 240 which are sequentially stacked. The boards 210, 220, 230, and 240 may include first through-holes 207a, second through-holes 207b, third through-holes 207c, and coils 213, 223, 233, and 243. A material layer (not shown) may be disposed between the boards. The material layer may be copper clad laminated (CCL) layer.

A width of each of the inductance boards 210, 220, 230, and the conduction board 240 may be about 5 cm and each of the inductance boards 210, 220, 230, and the conduction 240 may have a square-shape.

The first inductance board 210 may include a connector 212. The connector 212 may be disposed at one end of the first inductance board 210. The connector 212 may be provided for being connected to an electronic device. The connector 212 may be a SMA connector.

The first and second through-holes 207a and 207b of the first inductance board 210 may be spaced apart from each other and face the connecter 212.

A first inductance coil 213 may be disposed on an edge of the first inductance board 210. The first inductance coil 213 may be a power coil or a load coil. Forming the first inductance coil 213 may include forming a copper layer on the first inductance board 210; and patterning the copper layer. The first inductance coil 213 may be connected from the first through-hole 207a to the third through-hole 207c along the edge of the first inductance board 210. The third through-hole 207c of the first inductance board 210 may be spaced apart from the first and second through-holes 207a and 207b of the first inductance board 210 and be disposed inside the first inductance coil 213 in a plan view. A rotation direction from the first through-hole 207a to the third through-hole 207c may be a counterclockwise direction on the first inductance board 210. A turn number of the first inductance coil 213 may have a range of 1 to 10. In the present embodiment, the turn number of the first inductance coil 213 is 3. The first inductance coil 213 may be connected to the connector 212 at the first through-hole 207a. The first inductance coil 213 may have a diameter of about 0.5 mm.

A minimum spacing distance wb between portions of the first inductance coil 213 facing each other may be about 0.6 mm, and a maximum spacing distance between portions of the first inductance coil 213 facing each other may be about 4.5 cm.

Each of a second inductance coil 223 and a third inductance coil 233 respectively disposed on the second and third inductance boards 220 and 240 may be disposed to be overlapped with the first inductance coil 213 and have the same turn number as the first inductance coil 213 along the same rotation direction as the first inductance coil 213. Each of the second and third inductance coils 223 and 233 may have a diameter of about 0.5 mm. A minimum spacing distance wb between portions facing each other of each of the second and third inductance coils 223 and 233 may be about 0.6 mm, and a maximum spacing distance between portions facing each other of each of the second and third inductance coils 223 and 233 facing each other may be about 4.5 cm.

The first, second, and third inductance coils 213, 223, and 233 may be connected to each other by a first inductance conductive pillar (not shown) and a second inductance conductive pillar (not shown). The first inductance conductive pillar may pass through the first through-holes 207a of the first to third inductance boards 210, 220, and 230, and the second inductance conductive pillar may pass through the third through-holes 207c of the first to third inductance boards 210, 220, and 230. As a result, a resistance of the inductance structure may be reduced to one-third (⅓).

A fourth conduction coil 243 disposed on the fourth conduction board 240 may be connected from the second through-hole 207b to the third through-hole 207c of the fourth conduction board 240.

According to embodiments of the inventive concept, the wireless power transfer device may include eight printed circuit boards which are stacked. The boards include the base board, and first interposer boards and the second interposer boards alternately stacked on the base board. The stacked boards may constitute one resonance structure. A plurality of the resonance structures may be bonded to each other by the adhesive layers to realize the wireless power transfer device. The resonance structures may be vertically stacked using the adhesive layers, such that a planar area of the resonance structures may be minimized and the capacitance of the wireless power transfer device may increase. Thus, the resonance frequency of the wireless power transfer device may be reduced. Additionally, the wireless power transfer device may further include the inductance structure. Thus, it is possible to realize the wireless power transfer device of which the inductance is not limited. As a result, the wireless power transfer device with small size and high reliability may be realized.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A wireless power transfer device comprising:
a plurality of stacked resonance structures; and
adhesive layers between the resonance structures,
wherein each of the resonance structures includes a base board including a base coil, interposer boards including interposer coils and stacked on the base board, and conductive pillars penetrating the base board and the interposer board; and
wherein the conductive pillars connect the interposer boards to each other.

2. The wireless power transfer device of claim 1, wherein a length of one side of each of the resonance structures is about 5 cm.

3. The wireless power transfer device of claim 1, wherein a total stack number of the base board and the interposer boards is eight in each of the resonance structures.

4. The wireless power transfer device of claim 1, wherein each of the resonance structures has a thickness of about 0.73 mm.

5. The wireless power transfer device of claim 1, wherein each of the adhesive layers has a thickness of about 0.05 mm.

6. The wireless power transfer device of claim 1, wherein the base coil includes a base induction coil and a base resonance coil;
wherein each of the base induction coil and the base resonance coil extends in a first rotation direction; and
wherein a turn number of the base resonance coil is greater than a turn number of the base induction coil.

7. The wireless power transfer device of claim 1, wherein the interposer boards include first interposer boards and second interposer boards which are alternately stacked;
wherein each of the first interposer boards includes a first interposer induction coil and a first interposer resonance coil; and
wherein each of the second interposer boards includes a second interposer induction coil and a second interposer resonance coil.

8. The wireless power transfer device of claim 7, wherein a turn number of the first interposer induction coil is equal to a turn number of the second interposer induction coil.

9. The wireless power transfer device of claim 7, wherein a turn number of the first interposer resonance coil is greater than a turn number of the first interposer induction coil; and
wherein a turn number of the second interposer resonance coil is greater than a turn number of the second interposer induction coil.

10. The wireless power transfer device of claim 7, wherein the first interposer resonance coil extends in a first rotation direction; and
wherein the second interposer resonance coil extends in a second rotation direction opposite to the first rotation direction.

11. The wireless power transfer device of claim 7, wherein the conductive pillars includes a first conductive pillar, a second conductive pillar, a third conductive pillar, and a fourth conductive pillar;
wherein the first conductive pillar connects first ends of the base induction coil, the first interposer induction coils, and the second interposer induction coils to each other;
wherein the second conductive pillar connects second ends of the base induction coil, the first interposer induction coils, and the second interposer induction coils to each other;
wherein the third conductive pillar connects one-end of the base resonance coil and one-ends of the second interposer resonance coils to each other; and
wherein the fourth conductive pillar connects one-ends of the first interposer resonance coils to each other.

12. The wireless power transfer device of claim 1, wherein each of the base board and the interposer boards is formed of a printed circuit board.

13. The wireless power transfer device of claim 1, further comprising:
an inductance structure bonded to an uppermost layer or a lowermost layer of the resonance structures.

14. The wireless power transfer device of claim 13, wherein the inductance structure includes inductance boards and conduction board which are stacked; and
wherein the inductance boards include inductance coils and the conduction boards includes conduction coil in, respectively.

15. The wireless power transfer device of claim 14, wherein the inductance structure further includes a first inductance conductive pillar connecting first ends of the inductance coils to each other, and a second inductance conductive pillar connecting second ends of the inductance coils to each other.

16. The wireless power transfer device of claim 13, wherein a length of one side of the inductance structure is about 5 cm.
